(19) United States
(12) Patent Application Publication
(10) Pub. No.: US 2013/0133921 A1
(43) Pub. Date: May 30, 2013

(54) ANTI-CAPILLARY RESISTOR WIRE

(71) Applicant: Prestolite Wire LLC, Southfield, MI (US)

(72) Inventor: Frederick J. Kelley, Lexington, MI (US)

(73) Assignee: PRESTOLITE WIRE LLC, Southfield, MI (US)

(21) Appl. No.: 13/686,613

(22) Filed: Nov. 27, 2012

Related U.S. Application Data
(60) Provisional application No. 61/564,092, filed on Nov. 28, 2011.

(51) Int. Cl. H01B 7/00; H01B 3/00; H01F 41/06

(52) U.S. Cl. CPC H01B 7/0054; H01F 41/06; H01B 3/008
USPC 174/120 C; 29/605; 174/110 R; 174/120 SC

(57) ABSTRACT

A wire assembly includes a plurality of strength members, a first coating layer disposed on the strength members, and a conductive element helically wound about the first coating layer. The conductive element has a length associated with a predetermined resistance. A second coating layer is disposed on the conductive element, an the second coating layer is applied to the conductive element and the first coating layer via pressure extrusion to eliminate air gaps between at least a portion of the first coating layer and the second coating layer. A method of forming the wire assembly includes coating the strength members with the first coating layer, helically winding the conductive element about the first coating layer, and applying the second coating layer to the conductive element and the first coating layer via pressure extrusion to eliminate air gaps between at least a portion of the first and second coating layers.

### CROSS REFERENCE TO RELATED APPLICATIONS

This application claims priority to provisional patent application 61/564,092, filed on Nov. 28, 2011, the contents of which is hereby incorporated by reference in its entirety.

### BACKGROUND

A wire assembly generally includes a collection of wires and other electrical components used to convey electrical signals or power. In some wire assemblies, copper wires are terminated to both ends of a resistor with an over mold that provides the terminations and the resistor with some protection from moisture and corrosion. The over mold does little, however, to provide long-term sealing protection or protection against breakage. Moreover, each termination of the wire to the resistor is generally formed from solder, which adds to the expense of manufacturing wire assemblies.

### BRIEF DESCRIPTION OF THE DRAWINGS

FIG. 1 is a stepped cutaway view of different layers of an exemplary wire assembly.

FIG. 2 illustrates a flowchart of an exemplary method that may be used to manufacture the wire assembly of FIG. 1.

### DETAILED DESCRIPTION

A wire assembly includes a plurality of strength members, a first coating layer disposed on the strength members, and a conductive element helically wound about the first coating layer. The conductive element has a length associated with a predetermined resistance. A second coating layer is disposed on the conductive element, an the second coating layer is applied to the conductive element and the first coating layer via pressure extrusion to eliminate air gaps between at least a portion of the first coating layer and the second coating layer. A method of forming the wire assembly includes coating the plurality of strength members with the first coating layer, helically winding a conductive element about the first coating layer, and applying the second coating layer to the conductive element and the first coating layer via pressure extrusion to eliminate air gaps between at least a portion of the first coating layer and the second coating layer.

The exemplary wire assembly may protect the conductive element from moisture and control the specific amount of resistance in series or parallel with an electronic device. The controlled resistance of the conductive element may eliminate the need for additional series resistors or semiconductors and the associated solder terminations, resulting in a less expensive and simplified design. Moreover, the resistance of the conductive element may be adjusted during the manufacturing process to provide a wide range of desired resistance values and current ratings while still performing its role as a connector for electrical components. In addition, the wire assembly may provide an enhanced solid construction that prevents moisture from wicking through the conductive element and flowing into connected electronic components, especially during thermal cycling. Ultimately, the anti-capillary feature may prevent corrosion and premature failure of expensive electronics. The wire assembly as a whole may provide improved flexibility and vibration resistance due to the use of flexible conductor and insulator materials and the elimination of rigid electrical components, such as resistors or semiconductors, while simultaneously reducing bulk and weight.

The exemplary wire assembly may have a positive impact by enabling anti-capillary resistance wire technology to provide performance beyond the current limits of stranded metal conductor wire and cable products. For example, the wire assembly may protect vulnerable electronic components from moisture and corrosion in areas such as transportation light emitting diode (LED) lighting required by many original equipment manufacturer (OEM) customers.

As a particular example, the trucking industry is concerned with corrosion prevention, and specialized sealed connections have been unable to solve the intrusion of moisture into such components. The disclosed exemplary wire assembly may eliminate terminations, terminals, resistors, semiconductors and other electrical components, and an over mold while providing better quality and reliability through reduction of complexity and corrosion-prone parts. The wire assembly, therefore, will have a positive impact due to the reduction of quality problems and component cost while protecting components to achieve a longer useful life. As already noted above, assembly complexity, bulk, and weight are also minimized.

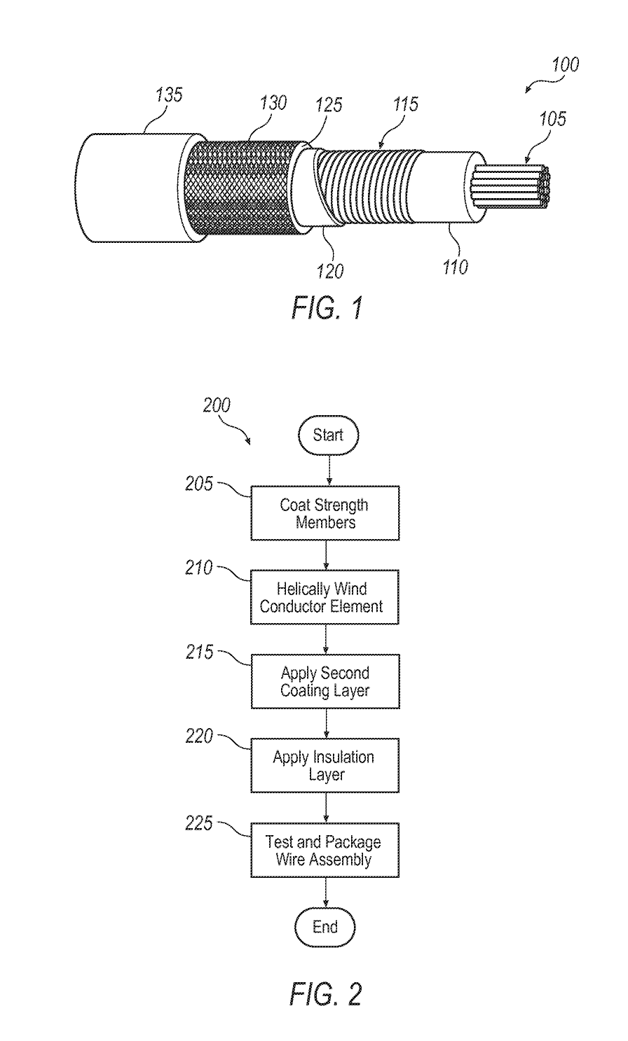

FIG. 1 illustrates an exemplary wire assembly that may take many different forms and include multiple and/or alternate components and facilities. While an exemplary wire assembly is shown, the exemplary components illustrated are not intended to be limiting. Indeed, additional or alternative components and/or implementations may be used.

FIG. 1 illustrates different layers of an exemplary wire assembly 100. As illustrated, the wire assembly 100 includes strength members 105, a first coating layer 110, a conductive element 115, a second coating layer 120, an insulation layer 125, a shield 130, and a jacket 135.

The strength members 105 may be configured to structurally support to the wire assembly 100 yet allow some flexibility. In one exemplary approach, each strength member 105 may include a strand or fiber of one or more of the following materials: glass, aramid fiber, metal, solid plastic, etc. The strength members 105 may be alternatively formed from one or more different materials or a combination of materials.

The first coating layer 110 may be disposed on the strength members 105. In one possible approach, the first coating layer 110 may be formed from any material that allows the strength member 105 to maintain a desired amount of flexibility while limiting movement of moisture among the strength members 105. Some properties of the first coating layer 110 may include low thermal conductivity, low chemical reactivity, electrical insulation, sufficient adhesion to the strength members 105, etc. Representative examples of materials used in the first coating layer 110 may include forms of latex or silicone.

The first coating layer 110 may be adhered to the strength members 105 in a way that at least partially fills air gaps that would otherwise exist between the strength members 105. For example, the first coating layer 110 may sometimes exist in a fluid form that can be cured or otherwise hardened. During manufacture of the wire assembly 100, the strength members 105 may be bundled and dipped into the fluid form of the first coating layer 110. When in fluid form, the first coating layer 110 may have a viscosity that allows the fluid material to flow into and fill air gaps between strength members 105. The first coating layer 110 may solidify when cured or otherwise hardened. Moreover, the adhesive properties of the first coating layer 110 may allow the first coating layer 110 to remain adhered to the strength members 105 even after solidifying.

In addition to having the characteristics above, the first coating layer 110 may have other characteristics based upon the intended use of the wire assembly 100. For instance, the first coating layer 110 may be formed from a material that can adequately protect the strength members 105 from water if the wire assembly 100 will be subject to moisture caused by humidity. The first coating layer 110 may be formed from a material that can seal the strength members 105 from oil if the wire assembly 100 will likely be exposed to oil.

The conductive element 115 may be helically wound about the first coating layer 110. The conductive element 115 may be formed from any conductive material such as, copper, aluminum, tin, gold, or the like depending on the desired magnitude of resistance, referred to as a predetermined resistance below. The conductive material 115 may further be formed from a conductive material that can, e.g., be drawn into a wire or rolled into a foil. For instance, the conductive element 115 may include the foil where relatively low resistance is desired or the wire where relatively high resistance is desired. Various physical properties of the conductive element 115 may contribute to the resistance of the conductive element 115. For example, the length, cross-sectional area, thickness, gauge, and resistivity of conductor material used may each contribute to the resistance. Controlling one or more of these properties of the conductive element 115 may be used to adjust the resistance of the conductive element 115 to achieve the predetermined resistance.

The predetermined resistance may include a minimum desired value of resistance needed for proper operation of the wire assembly 100. By manufacturing the conductive element 115 to contain the predetermined resistance, the wire assembly 100 can operate despite omitting certain components such as resistors and over molds located at terminal ends of the wire assembly 100. The conductive element 115 may contribute most or all of the predetermined resistance to the wire assembly 100. Other components may also contribute to the predetermined resistance, as discussed in greater detail below.

Any number of characteristics of the conductive element 115 may be manipulated to manufacture the wire assembly 100 with the predetermined resistance. These characteristics may include the resistivity of the material used to form the conductive element 115, the length of the conductive element 115, and the cross-sectional area or thickness of the conductive element 115. In one possible implementation, the conductive element 115 may include a wire helically wound about the first coating layer 110 to form a coil wrap. The length and size of the wire may be associated with the predetermined resistance. That is, the resistance of the wire may be directly proportional to the length of the wire and inversely proportional to the cross-sectional area or thickness of the wire. During manufacture, the wire may be drawn to have a substantially uniform cross-sectional area and length associated with the predetermined resistance and other constraints. Since the wire is wound about the first coating layer 110, the resistance of the coil wrap may be associated with a specific number of turns per inch, yard, or any other measure of distance, depending on the circumference of the first coating layer 110. Alternatively, the conductive element 115 may include foil wound about the first coating layer 110 to form a foil wrap. As with the coil wrap, the length and cross-sectional area or thickness of the foil may be associated with the predetermined resistance. Accordingly, the resistance of the foil wrap may be associated with a specific number of turns per unit of length depending on the circumference of the first coating layer 110.

The second coating layer 120 may be disposed on the conductive element 115 and first coating layer 110. The second coating layer 120 may be formed from the same or a different material than the first coating layer 110. Like the first coating layer 110, the material of the second coating layer 120 may allow for a minimum amount of flexibility and may be selected to accommodate the intended use of the wire assembly 100. For instance, the second coating layer 120 may be formed from a material that can prevent water infiltration if humidity or water exposure is expected of possible. A material that can seal the conductive element 115 from oil infiltration may be used if oil exposure is likely. The second coating layer 120 may be further formed from a material that can adhere to the conductive element 115 and the first coating layer 110. The second coating layer 120 may have additional properties such as low thermal conductivity and low chemical reactivity. Representative examples of materials used for the second coating layer 120 may include forms of silicone or latex. In some situations both coating 110 and coating 120 may be formed from the same compound. In some implementations, the second coating layer 120 may be formed from an insulating material. The second coating layer 120 may be alternatively formed from a semiconductor material. Generally, semiconductor materials exhibit more electrical conductivity than an insulator but less than a conductor, such as the conductive element 115. Semiconductors may further exhibit resistivity. In this implementation where the second coating layer 120 is formed from a semiconductor material, the resistivity of the second coating layer 120 may further contribute to the predetermined resistance. Accordingly, the length of the conductive element 115 may be shorter or the cross-sectional thickness of the conductive element 115 may be larger if the second coating layer 120 includes a semiconductor material.

Air gaps near the strength members 105, the first coating layer 110, the conductive element 115, and the second coating layer 120 may cause moisture to wick through the wire assembly 100. One way to eliminate air gaps between the strength members 105 is discussed above. One way to eliminate air gaps between at least a portion of the first coating layer 110, the conductive element 115, and the second coating layer 120, and thus seal the conductive element 115 from moisture, is to apply the second coating layer 120 to the conductive element 115 and first coating layer 110 via pressure extrusion. When applied through pressure extrusion, the second coating layer 120 fills air gaps that could otherwise exist between at least a portion of the first and second coating layers 110, 120 and the conductive element 115. The portion of the first and second coating layers 110, 120 sealed may be of any length to prevent moisture from collecting in and wicking through the wire assembly 100. The length of the sealed portion may be measured by any unit of distance, such as millimeters, centimeters, inches, feet, meters, yards, etc., depending on the overall length of the wire assembly 100. Alternative methods of applying the second coating layer 120 to the conductive element 115 may also provide sufficient protection by, e.g., reducing a significant number of air gaps or even eliminating the air gaps altogether.

The insulation layer 125 may include any material that may be disposed on the second coating layer 120 to provide further protection to the wire assembly 100 while allowing the wire assembly 100 to remain sufficiently flexible. The insulation layer 125 may be formed from the same or a different material than the first coating layer 110 or the second coating layer 120. The insulation layer 125 may be applied to the second coating layer 120 via an extrusion process. In some instances, such as low-voltage implementations, the insulation layer 125 may be the outermost layer of the wire assembly 100. Other implementations, however, may necessitate additional layers. For instance, in higher voltage instances, for noise prevention, or for shield 130ing purposes, additional layers, such as the shield 130 and the jacket 135, may be used.

The shield 130 may be configured to protect the conductive element 115 from electrical interference as well as prevent the conductive element 115 from transmitting interfering signals. For example, the shield 130 may include a metal mesh or braided wires wrapped about the insulation layer 125. In operation, the shield 130 may be configured to disperse electromagnetic fields generated or received by the conductive material.

The jacket 135 may be disposed on the shield 130 and allow for sufficient flexibility and insulation of the wire assembly 100. The jacket 135 may be formed from the same or a different material than the insulation layer 125, the first coating layer 110, or the second coating layer 120.

FIG. 2 illustrates an example process 200 that may be used to assemble the components of the wire assembly 100. Any of the steps of the process 200 may be performed simultaneously or sequentially.

At block 205, the strength members 105 may be coated with the first coating layer 110. One way to coat the strength members 105 is to bundle the strength members 105 and dip the bundled strength members 105 into a fluid form of the first coating layer 110. Dipping the strength members 105 into the liquid form of the first coating layer 110 may allow the first coating layer 110 to substantially fill and eliminate air gaps between the strength members 105. This reduction of air gaps may effectively prevent moisture from wicking through the strength members 105. Coating the plurality of strength members 105 may further include curing or otherwise hardening the first coating layer 110. The first coating layer 110 may be cured chemically or may simply harden over time. After the first coating layer 110 cures or hardens, the process 200 may continue at block 210.

At block 210, the conductive element 115 may be helically wound about the first coating layer 110. For instance, the conductive element 115 may be drawn into a wire or rolled into a foil and applied to the first coating layer 110 in a generally spiral fashion to form either a coil wrap or a foil wrap, respectively. The length or cross-sectional thickness of the conductive element 115 may be selected based upon a desired, predetermined resistance of the conductive element 115. The resistance of the conductive element 115 may be designated as a number of turns per unit of length, depending upon the circumference of the first coating layer 110.

At block 215, the second coating layer 120 may be applied to the conductive element 115 and the first coating layer 110. The second coating element may be applied via pressure extrusion to reduce or otherwise fill air gaps that would otherwise exist on or near the first coating layer 110, the second coating layer 120, and the conductive element 115. Eliminating air gaps may reduce or prevent moisture wicking through the wire assembly 100.

At block 220, the insulation layer 125 may be applied to the second coating layer 120 via, e.g., extrusion. In one exemplary approach, the process 200 may continue at block 225 after the insulation layer 125 is applied. In some instances, however, the extrusion that occurs at block 220 may further apply the shield 130, jacket 135, or both, to the wire assembly 100. Relative to the insulation layer 125, the shield 130 and jacket 135 may be subsequently or simultaneously applied to the wire assembly 100.

At block 225, the wire assembly 100 may be tested and packaged depending on the outcome of the testing. The process 200 may end after block 225.

### CONCLUSION

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A wire assembly comprising:
a plurality of strength members;
a first coating layer disposed on the strength members;
a conductive element helically wound about the first coating layer and having a length associated with a predetermined resistance; and
a second coating layer disposed on the conductive element, wherein the second coating layer is applied to the conductive element and the first coating layer via pressure extrusion to eliminate air gaps between at least a portion of the first coating layer and the second coating layer.

2. The wire assembly of claim 1, wherein the first coating layer is applied to the plurality of strength members in fluid form to eliminate air gaps between the plurality of strength members.

3. The wire assembly of claim 1, wherein the conductive element has a substantially uniform cross-sectional thickness, and wherein the predetermined resistance is directly proportional to the length of the conductive element and inversely proportional to the cross-sectional thickness of the conductive element.

4. The wire assembly of claim 1, wherein the predetermined resistance is based on a number of turns per unit length of the conductive element.

5. The wire assembly of claim 1, further comprising an insulation layer disposed on the second coating layer.

6. The wire assembly of claim 1, wherein the conductive element has a resistivity associated with the predetermined resistance.

7. The wire assembly of claim 1, wherein the second coating layer includes a semiconductor material having a resistivity that contributes to the predetermined resistance.

8. The wire assembly of claim 1, wherein each strength member is formed from at least one of the following materials: glass, aramid fiber, metal, and plastic.

9. A method comprising:
coating a plurality of strength members with a first coating layer;
helically winding a conductive element about the first coating layer, wherein the conductive element has a length associated with a predetermined resistance; and
applying a second coating layer to the conductive element and the first coating layer via pressure extrusion to eliminate air gaps between at least a portion of the first coating layer and the second coating layer.

10. The method of claim 9, wherein helically winding the conductive element about the first coating layer includes helically winding the conductive element about the first coating layer to have a particular number of turns per unit length.

11. The method of claim 9, wherein the conductive element has a substantially uniform cross-sectional thickness, and wherein the predetermined resistance is directly proportional to the length of the conductive element and inversely proportional to the cross-sectional thickness of the conductive element.

12. The method of claim 9, wherein coating the plurality of strength members with the first coating layer includes:
bundling the plurality of strength members; and
dipping the bundled strength members into a fluid form of the first coating layer material to eliminate air gaps between the plurality of strength members.

13. The method of claim 12, wherein coating the plurality of strength members with the first coating layer includes curing the first coating layer.

14. The method of claim 9, further comprising extruding an insulation layer onto the second coating layer.

15. The method of claim 9, wherein the conductive element has a resistivity associated with the predetermined resistance.

16. The method of claim 9, wherein the second coating layer includes a semiconductor material having a resistivity that contributes to the predetermined resistance.

17. A wire assembly comprising:
a plurality of strength members;
a first coating layer applied to the strength members in fluid form to eliminate air gaps between the plurality of strength members;
a conductive element helically wound about the first coating layer after the first coating layer has cured, wherein the conductive element has a length and resistivity proportional to a predetermined resistance and a substantially uniform cross-sectional thickness inversely proportional to the predetermined resistance;
a second coating layer disposed on the conductive element, wherein the second coating layer is applied to the conductive element via pressure extrusion to eliminate air gaps between at least a portion of the first coating layer and the second coating layer; and
an insulation layer disposed on the second coating layer.

18. The wire assembly of claim 17, wherein the conductive element includes at least one of a wire and a foil.

19. The wire assembly of claim 17, wherein the predetermined resistance is based on a number of turns per unit length of the conductive element.

20. The wire assembly of claim 17, wherein the second coating layer includes a semiconductor material having a resistivity that contributes to the predetermined resistance.
